(19) United States
(12) Patent Application Publication
(10) Pub. No.: US 2026/0352565 A1
(43) Pub. Date: Nov. 5, 2026

(54) AUTOMATIC SERVICE MODELING USING MACHINE LEARNING

(71) Applicant: Micro Focus LLC, Wilmington, DE (US)

(72) Inventors: Yi-Ming Chen, Shanghai (CN); Qiuxia Song, Shanghai (CN)

(73) Assignee: Micro Focus LLC, Wilmington, DE (US)

(21) Appl. No.: 19/197,966

(22) Filed: May 2, 2025

(51) Int. Cl. H04L 41/16; H04L 47/24

(52) U.S. Cl. CPC H04L 41/16; H04L 47/24

(57) ABSTRACT

A trained machine learning algorithm automatically generates one or more service models that define relationships between configuration items. The machine learning algorithm is trained with a dependency matrix that identifies network patterns and defines corresponding dependency values and weights for each identified network pattern. The dependency matrix is generated using network discovery data.

### FIELD

This disclosure relates generally to service modeling, and particularly to using machine learning algorithms to automatically generate service models.

### BACKGROUND

Service modeling is a way to represent the relationships between IT infrastructure components (e.g., devices, applications, and groups) that are necessary to support a business service. For example, an e-commerce company's business service (e.g., online shopping) can be represented by a service model that shows the relationships between the server hosting the website, the website application, the inventory system, the payment gateway, and the database.

### SUMMARY

Example aspects of the present disclosure include:

A system according to at least one embodiment of the present disclosure includes a microprocessor; and a computer readable medium, coupled with the microprocessor and comprising microprocessor readable and executable instructions that, when executed by the microprocessor, cause the microprocessor to: receive input data, wherein input data comprises network discovery data; generate, using the network discovery data, a dependency matrix that identifies network patterns and defines corresponding dependency values and weights for each identified network pattern; and train a machine learning algorithm using the dependency matrix, wherein the trained machine learning algorithm is used to: group a plurality of configuration items to generate one or more service models.

A non-transitory computer-readable data storage medium according to at least one embodiment of the present disclosure stores program code executable by a computing system on which a database management system (DBMS) is running to: receive input data, wherein input data comprises network discovery data; generate, using the network discovery data, a dependency matrix that identifies network patterns and defines corresponding dependency values and weights for each identified network pattern; and train a machine learning algorithm using the dependency matrix, wherein the trained machine learning algorithm is used to: group a plurality of configuration items to generate one or more service models.

A method according to at least one embodiment of the present disclosure includes training a machine-learning model to automatically generate one or more service models, wherein the machine-learning model is trained with a dependency matrix that identifies network patterns and defines corresponding dependency values and weights for each identified network pattern, and wherein the dependency matrix is generated using network discovery data.

Any of the aspects herein, wherein the service model defines a set of configuration items and relationships between each configuration item in the set of configuration items.

Any of the aspects herein, wherein the discovery data comprises one or more relationships between the plurality of configuration items, and wherein the dependency matrix is adjusted based on time coefficients of each of the one more relationships.

Any of the aspects herein, wherein a relationship between configuration items is deleted after a predetermined period of time.

Any of the aspects herein, wherein the plurality of configuration items include network devices, and wherein a network pattern comprises network traffic between the network devices.

Any of the aspects herein, wherein the plurality of configuration items include network devices, and wherein a network pattern comprises a naming convention of devices.

Any of the aspects herein, further comprising: intelligently suggesting configuration items for a new service model; and storing the new service model.

Any of the aspects herein, further comprising: discovering a new service model; and prompting a user for input on whether or not to store the newly discovered service model.

Any of the aspects herein, wherein a configuration item of the plurality of configuration items comprises a device.

Any of the aspects herein, wherein a configuration item of the plurality of configuration items comprises an application.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

These and other needs are addressed by the various embodiments and configurations of the present disclosure. The present disclosure can provide a number of advantages depending on the particular configuration. These and other advantages will be apparent from the disclosure contained herein.

Service modeling is crucial for effective IT Service Management (ITSM) because it provides a structured approach to understanding, designing, managing, and improving IT services. A service model is a set of configuration items (CI(s)) and relationships working together to provide an IT service. Service modeling helps visualize dependencies, assess the impact of technical issues on business operations, and link technical problems to business services.

Components of a service model include: a business service, a technical service tier, an infrastructure tier, and configuration items (CIs). The business service defines logical entities that represent a service provided by the business (e.g., e-commerce platform, an HR system, etc.). The technical service tier relates to the systems and applications that support the business service (e.g., a catalog and inventory system). The infrastructure tier defines the underlying infrastructure components (e.g., servers and databases) that provide resources for the technical service tier. The configuration items are the individual components that make up the service (e.g., software, devices, application, and groups).

There are several types of service modeling: (1) Instance-based modeling-a method to manually add CI(s) to an existing service model; (2) Pattern-based modeling-a method to let users define a query for CIs (e.g., TQL) and add all results to an existing service model; and (3) Automated Service Modeling (ASM)—a discovery feature that can discover a service model given the endpoint uniform resource identifier (URI) and the credential to access all used devices. Although ASM can automatically create service models based on discovery techniques, it is still limited. ASM requires full device access to all devices for thorough discovery. Furthermore, ASM currently supports only a limited range of software (based on pre-defined templates such as Tomcat and WebSphere).

The present disclosure uses discovery data to generate a dependency matrix that defines common network patterns (e.g., network traffic between devices, ports used, ADP used, etc.), and further assigns dependency values and weights, and incorporates time efficiency to adjust these values based on the age of the relationships (e.g., older relationships are weighted less than more recent relationships). The dependency matrix is refined to reduce directionality, and used to cluster nodes (e.g., CIs) through machine learning. Additionally, the present disclosure extends to Artificial Intelligence (AI) based assisted modeling, offering intelligent guidance for users in selecting CI(s) for service models. The present disclosure enhances automation, accuracy, and scalability in Service Modeling, and provides valuable user assistance.

A trained machine learning algorithm automatically generates one or more service models that define relationships between configuration items. The machine-learning model is trained with a dependency matrix that identifies network patterns and defines corresponding dependency values and weights for each identified network pattern. The dependency matrix is generated using network discovery data.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

As described herein, the terms “Artificial Intelligence (AI) algorithm” and “Machine Learning (ML) algorithm” may be used interchangeably.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for training a Machine Learning algorithm to automatically generate service models in accordance with embodiments of the present disclosure.

FIG. 2 is a block diagram of a second illustrative system for training a Machine Learning algorithm to automatically generate service models in accordance with embodiments of the present disclosure.

FIG. 3A is a block diagram of a second illustrative system for training a Machine Learning algorithm to automatically generate service models in accordance with embodiments of the present disclosure.

FIG. 3B illustrates an example dependency matrix in accordance with embodiments of the present disclosure.

FIG. 3C illustrates an example output of the trained machine-learning algorithm in accordance with embodiments of the present disclosure.

FIGS. 4A-4B illustrate a block diagram of an example network in accordance with embodiments of the present disclosure.

FIG. 5 illustrates a flow diagram of a process for automatically generating service models in accordance with embodiments of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

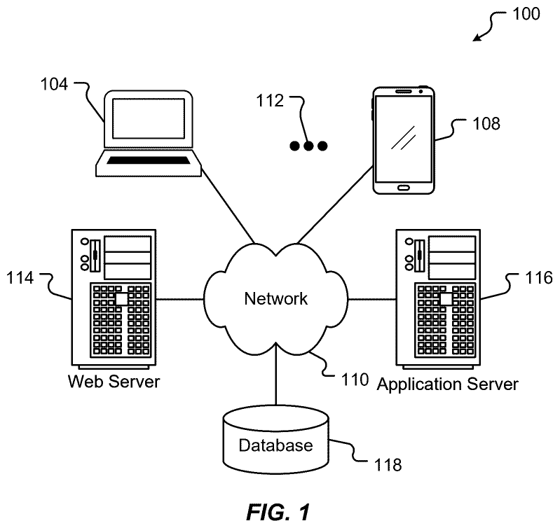

FIG. 1 is a block diagram illustrating elements of an exemplary computing environment 100 in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a computing device 108, and/or more computing devices 112.

The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The environment 100 may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C #®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

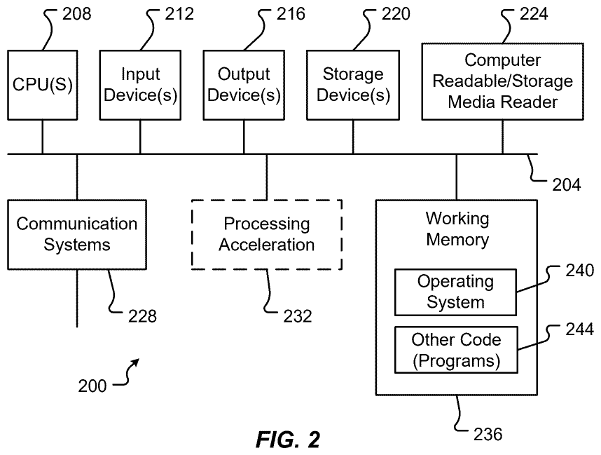

FIG. 2 is a block diagram illustrating elements of an exemplary computing system 200 in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more central processing units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the central processing units (CPUs) 208 as described herein may include, but are not limited to, at least one of Qualcomm® Snapdragon® 800 and 801, Qualcomm® Snapdragon® 620 and 615 with 4G LTE Integration and 64-bit computing, Apple® A 7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

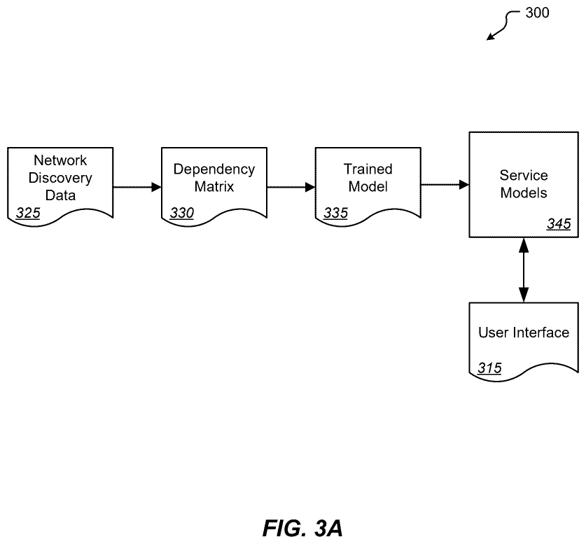

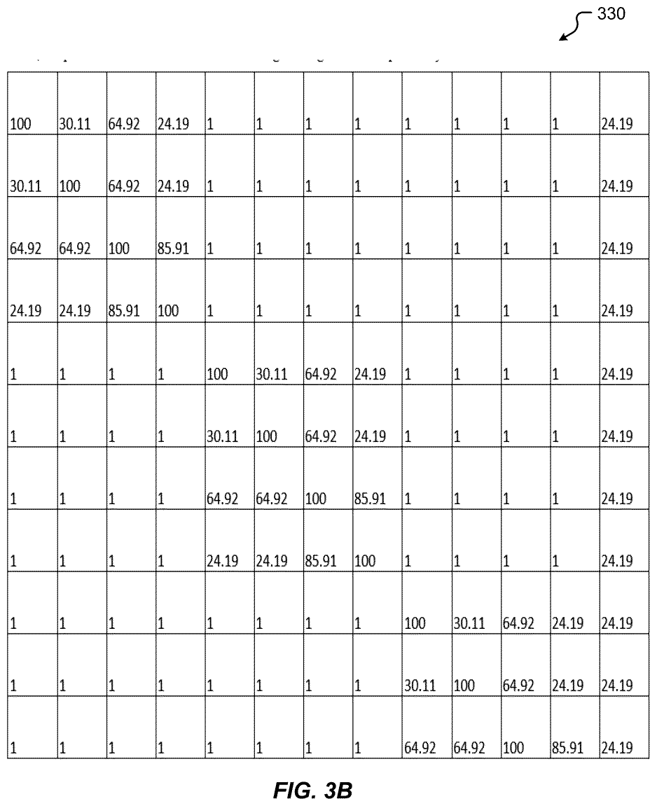

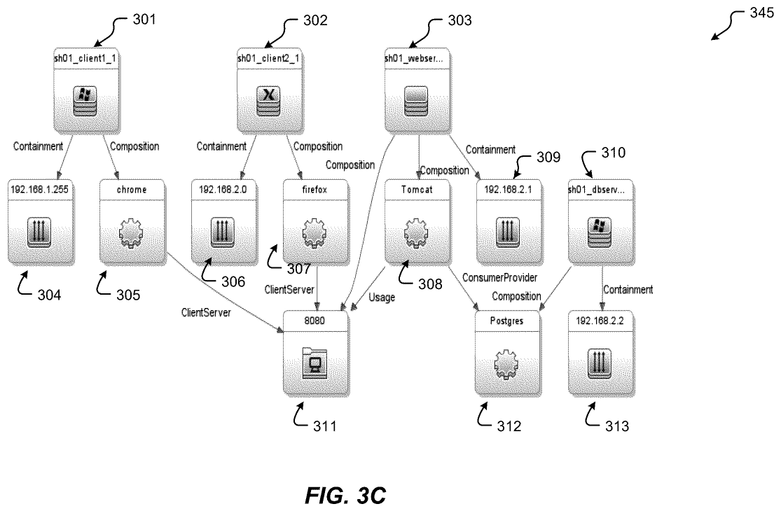

FIG. 3A is a block diagram of an illustrative system 300 for training a machine learning (ML) algorithm 300 to automatically generate service models 345. In embodiments, the input data 325 is generated by preforming discovery on a network. The input data is used to generate a dependency matrix 330 of the discovered configuration items. The dependency matrix 330 identifies network patterns and defines corresponding dependency values and weights for each identified network pattern. The dependency matrix 330 is used to train a machine-learning model to generate a trained model 335. The trained model 335 automatically generates service models 345, which may be displayed on user interface 315. After the trained model 335 generates the service models 345, a user may manually make adjustments to the generated service models 345. The user may also use the user interface 315 to add additional configuration items to a generated service model 345. Additionally, a user may input data to the service model 345 via the user interface 315. Once the service models 345 have been identified, they may be added to a drop down menu, so that if the user wants to put up another service, they can select the corresponding service model from the drop down menu.

FIG. 3B illustrates an example dependency matrix 330. In embodiments, the dependency matrix may be generated from network discover data on a network (e.g., network 400). The dependency matrix 330 is a square matrix where rows and columns represent configuration items, and each cell indicates the presence and strength of a dependency between the corresponding configuration items. The dependency matrix 330 is used to model and visualize dependencies between different configuration items, where each dependency is assigned a weight indicating its strength or importance. Unlike a simple binary DSM (which only shows the presence or absence of a dependency), a weighted DSM assigns a value (weight) to each dependency, reflecting its importance or impact.

FIG. 3C illustrates an example one or more services models 345 generated by the trained machine-learning model 335. As described herein, a service model may comprise one or more configuration items 301-313. Example configuration items, include but are not limited to, client devices (e.g., 301-302), web servers (e.g., 303), web browsers (e.g., 305 and 307), storage devices (e.g., 304, 306, 309, and 313), client servers (e.g., 311), and database servers (e.g., 310). As illustrated, configuration items 301, 304, 305, and 311 may comprise a service model 345. The configuration items 302, 306, 307, and 311 may comprise a second service model 345. The configuration items 303, 308, 309, 310, 311, 312, and 313 may comprise a third service model 345.

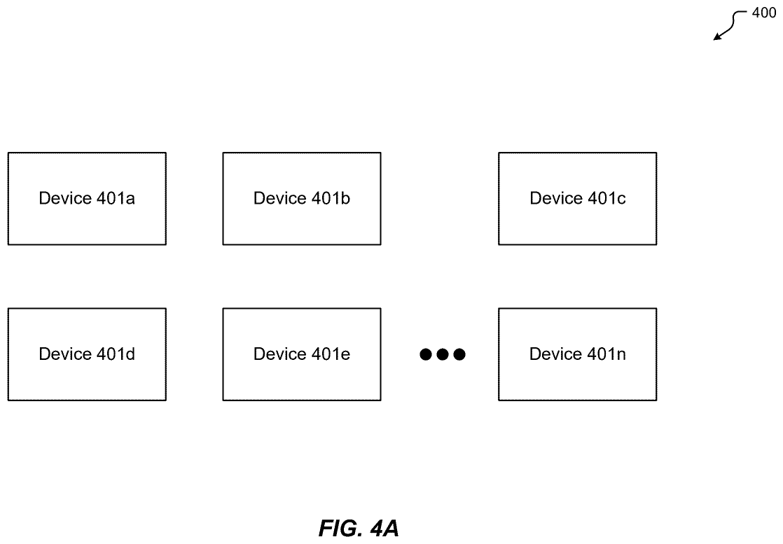

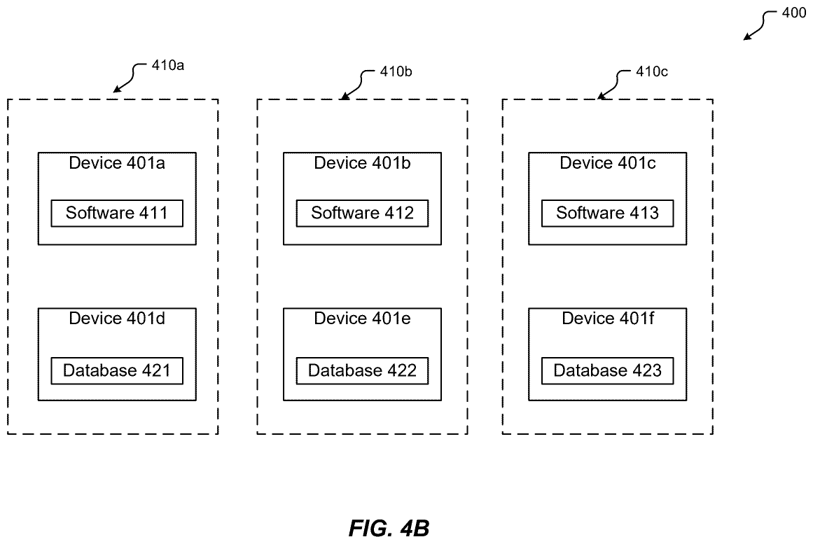

FIGS. 4A-4B illustrate a block diagram of an example network 400.

FIG. 4A illustrates network discovery data after a discovery is performed on the network 400. Devices 401a-n are discovered.

FIG. 4B illustrates the configuration items (e.g., devices 401a-n, software 411-413, and databases 421-423) being grouped into respective service models 410a-c.

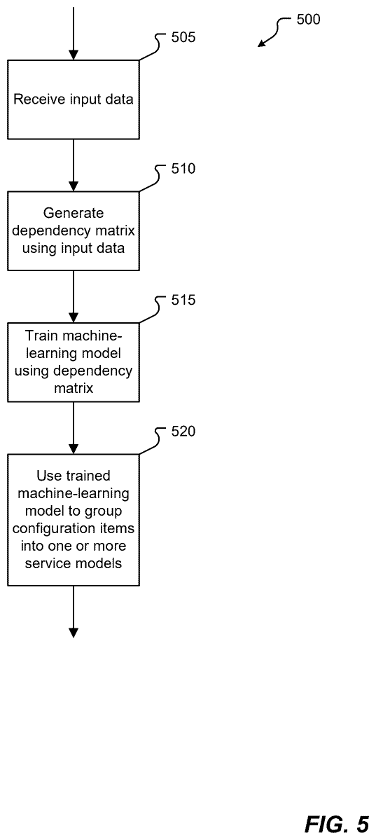

FIG. 5 is a flowchart illustrating an exemplary method 500 for using a trained machine learning model to automatically generate service models according to one embodiment of the present disclosure.

The method 500 (and/or one or more steps thereof) may be carried out or otherwise performed, for example, by at least one processor. The at least one processor may be the same as or similar to the central processing units (CPUs) 208 of the computing device 200 described above. A processor other than any processor described herein may also be used to execute the method 500. The at least one processor may perform the method 500 by executing elements stored in a memory such as the memory 236. The elements stored in memory and executed by the processor may cause the processor to execute one or more steps of a function as shown in method 500. One or more portions of a method 500 may be performed by the processor executing any of the contents of memory.

As illustrated in this example, method 500 begins with receiving input data (step 505). In embodiments, the input data comprises network discovery data, such as traffic patterns (e.g., which devices communicate with which other devices) used to determine relationships between device. The network discovery data is used to generate a dependency matrix (step 510). The dependency matrix identifies network patterns and defines corresponding dependency values and weights for each identified network pattern. In embodiments, older relationships are weighted less than more recent relationships. The dependency matrix is used to train a machine learning model (step 515). The trained machined learning model is to automatically generate service models (step 520). In embodiments, the trained machine learning model groups a plurality of configuration items to generate one or more service models.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

As used herein, “a” or “a number of” something can refer to one or more such things. For example, “a number of widgets” can refer to one or more widgets.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

The specification examples provide a description of the applications and use of the system and method of the present disclosure. Since many examples can be made without departing from the spirit and scope of the system and method of the present disclosure, this specification sets forth some of the many possible example configurations and implementations.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
receive input data, wherein the input data comprises network discovery data;
generate, using the network discovery data, a dependency matrix that identifies network patterns and defines corresponding dependency values and weights for each identified network pattern; and
train a machine learning algorithm using the dependency matrix, wherein the trained machine learning algorithm is used to:
group a plurality of configuration items to generate one or more service models.

2. The system of claim 1, wherein the one or more service models each defines a set of configuration items and relationships between each configuration item in the set of configuration items.

3. The system of claim 1, wherein the network discovery data comprises one or more relationships between the plurality of configuration items, and wherein the dependency matrix is adjusted based on time coefficients of each of the one more relationships.

4. The system of claim 3, wherein a relationship between configuration items is deleted after a predetermined period of time.

5. The system of claim 1, wherein the plurality of configuration items include network devices, and wherein a network pattern comprises network traffic between the network devices.

6. The system of claim 1, wherein the plurality of configuration items include network devices, and wherein a network pattern comprises a naming convention of devices.

7. The system of claim 1, further comprising:
intelligently suggesting configuration items for a new service model; and
storing the new service model.

8. The system of claim 1, further comprising:
discovering a new service model; and
prompting a user for input on whether or not to store the new service model.

9. The system of claim 1, wherein a configuration item of the plurality of configuration items comprises a device.

10. The system of claim 1, wherein a configuration item of the plurality of configuration items comprises an application.

11. A non-transitory computer-readable data storage medium storing program code executable by a computing system on which a database management system (DBMS) is running to:
receive input data, wherein the input data comprises network discovery data;
generate, using the network discovery data, a dependency matrix that identifies network patterns and defines corresponding dependency values and weights for each identified network pattern; and
train a machine learning algorithm using the dependency matrix, wherein the trained machine learning algorithm is used to:
group a plurality of configuration items to generate one or more service models.

12. The non-transitory computer-readable data storage medium of claim 11, wherein the one or more service models each defines a set of configuration items and relationships between each configuration item in the set of configuration items.

13. The non-transitory computer-readable data storage medium of claim 11, wherein the network discovery data comprises one or more relationships between the plurality of configuration items, and wherein the dependency matrix is adjusted based on time coefficients of each of the one more relationships.

14. The non-transitory computer-readable data storage medium of claim 13, wherein a relationship between configuration items is deleted after a predetermined period of time.

15. The non-transitory computer-readable data storage medium of claim 11, wherein the plurality of configuration items include network devices, and wherein a network pattern comprises network traffic between the network devices.

16. The non-transitory computer-readable data storage medium of claim 11, wherein the plurality of configuration items include network devices, and wherein a network pattern comprises a naming convention of devices.

17. The non-transitory computer-readable data storage medium of claim 11, further comprising program code executable by the computing system on which the DBMS is running to:
intelligently suggest configuration items for a new service model; and
store the new service model.

18. The non-transitory computer-readable data storage medium of claim 11, further comprising program code executable by the computing system on which the DBMS is running to:
discover a new service model; and
prompt a user for input on whether or not to store the new service model.

19. The non-transitory computer-readable data storage medium of claim 11, wherein a configuration item of the plurality of configuration items comprises a device or an application.

20. A method comprising:
training a machine-learning model to automatically generate one or more service models, wherein the machine-learning model is trained with a dependency matrix that identifies network patterns and defines corresponding dependency values and weights for each identified network pattern, and wherein the dependency matrix is generated using network discovery data.
